(19) United States
(12) Patent Application Publication
(10) Pub. No.: US 2009/0040143 A1
(43) Pub. Date: Feb. 12, 2009

(54) Apparatus and method for driving a plasma display panel

(76) Inventor: Eun-Young Jung, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/222,156

(22) Filed: Aug. 4, 2008

(30) Foreign Application Priority Data
Aug. 7, 2007 (KR) 10-2007-0079164

(51) Int. Cl. G09G 3/28

(52) U.S. Cl. 345/60

(57) ABSTRACT

An apparatus for driving a plasma display panel that includes first and second substrates, X electrodes, Y electrodes, and A electrodes between the substrates, and a protective layer on a surface of at least one of the substrates and formed of a material including magnesium oxide and scandium, the apparatus including a first driver configured to generate sustain pulses and to apply the sustain pulses to at least one of the X electrodes and the Y electrodes, and a second driver configured to generate address short pulses and to apply the address short pulses to the A electrodes in synchronization with the sustain pulses.

### BACKGROUND OF THE INVENTION

1. Field of the Invention

Embodiment examples relate to an apparatus and methods for driving a plasma display panel (PDP). More particularly, example embodiments relate to an apparatus having a PDP with a protective layer of relative high secondary electron emission capacity and relative short discharge delay time and methods for driving the same.

2. Description of the Related Art

Plasma display panels (PDPs) have attracted considerable attention due to their characteristics of being large-size displays. When panel resolution is increased in order to realize an ultrahigh resolution PDP, pixel size decreases. Accordingly, a number of charged particles in the discharge cells may also decrease, such that a higher driving voltage may be required to maintain a desirable level of brightness. Thus, discharge efficiency may be lowered.

In order to reduce a driving voltage and reduce a discharge response time, a protective layer in discharge cells of the PDP may be formed of a material having a high capacity for secondary electron emission, a short discharge delay time, and little temperature dependency. Large secondary electron emission may lead to the formation of numerous charged particles in the discharge cells, which may not be maintained during an address waiting time. Accordingly, wall charges may be lost and a discharge failure may occur.

### SUMMARY OF THE INVENTION

Example embodiments are therefore directed to an apparatus for driving a PDP and methods thereof, which substantially overcome one or more of the disadvantages of the related art.

It is therefore a feature of an example embodiment to provide an apparatus for driving a PDP that includes a protective layer having a high secondary electron emission capacity, the apparatus applying address short pulses during a sustain discharge period to improve brightness and discharge efficiency.

It is therefore a feature of another example embodiment to provide a method of driving a PDP that includes a protective layer having a high secondary electron emission capacity, the method including applying address short pulses during a sustain discharge period to improve brightness and discharge efficiency.

At least one of the above and other features of example embodiments may be realized by providing an apparatus for driving a plasma display panel that includes first and second substrates, X electrodes, Y electrodes, and A electrodes between the substrates, and a protective layer on a surface of at least one of the substrates and formed of a material including magnesium oxide and scandium, the apparatus including a first driver configured to generate sustain pulses and to apply the sustain pulses to at least one of the X electrodes and the Y electrodes, and a second driver configured to generate address short pulses and to apply the address short pulses to the A electrodes in synchronization with the sustain pulses.

The address short pulses may have a pulse width less than a pulse width of the sustain pulses. The width of the address short pulses may be less than half the width of the sustain pulses. A voltage level of the address short pulses may be lower than a voltage level of the sustain pulses, and the voltage level of the address short pulses may be lower than a voltage level of address pulses applied to the A electrodes during an address period. The address short pulses may be aligned with the sustain pulses. One or more of the address short pulses may not be aligned with the sustain pulses.

A plurality of subfields may be sequentially arranged in one frame, and the address short pulses may be applied to at least one intermediate subfield of the plurality of subfields. A plurality of subfields may be sequentially arranged in one frame, the subfields may each include an address period and a sustain period, scan pulses may be sequentially applied to the Y electrodes during the address period, and address pulses synchronized with the scan pulses may be applied to A electrodes corresponding to discharge cells to be displayed, and the address short pulses may be applied during the sustain period. First sustain pulses having a positive voltage level and second sustain pulses having a negative voltage level may be alternately applied to the Y electrodes during the sustain period, and the address short pulses may include first address short pulses having a positive level applied in synchronization with the first sustain pulses, and second address short pulses having a negative level applied in synchronization with the second sustain pulses. The protective layer material may further include one or more of aluminum, calcium, or zirconium.

At least one of the above and other features of example embodiments may also be realized by providing a method of driving a plasma display panel that includes first and second substrates, X electrodes, Y electrodes, and A electrodes between the substrates, and a protective layer on a surface of at least one of the substrates and formed of a material including magnesium oxide and scandium, the method including generating sustain pulses, applying the sustain pulses to at least one of the X electrodes and the Y electrodes, generating address short pulses, and applying the address short pulses to the A electrodes in synchronization with the sustain pulses.

The address short pulses may have a pulse width less than a pulse width of the sustain pulses. The width of the address short pulses may be less than half the width of the sustain pulses. A voltage level of the address short pulses may be lower than a voltage level of the sustain pulses, and the voltage level of the address short pulses may be lower than a voltage level of address pulses applied to the A electrodes during an address period. The address short pulses may be aligned with the sustain pulses. One or more of the address short pulses may not be aligned with the sustain pulses.

A plurality of subfields may be arranged sequentially in one frame, and the address short pulses may be applied to at least one intermediate subfield of the plurality of subfields. A plurality of subfields may be sequentially arranged in one frame, the subfields may each include an address period and a sustain period, scan pulses may be sequentially applied to the Y electrodes during the address period, and address pulses synchronized with the scan pulses may be applied to A electrodes corresponding to discharge cells to be displayed, and the address short pulses may be applied during the sustain period. First sustain pulses having a positive voltage level and second sustain pulses having a negative voltage level may be alternately applied to the Y electrodes during the sustain period, and the address short pulses may include first address short pulses having a positive level applied in synchronization with the first sustain pulses, and second address short pulses having a negative level applied in synchronization with the second sustain pulses. The protective layer material may further include one or more of aluminum, calcium, or zirconium.

### BRIEF DESCRIPTION OF THE DRAWINGS

The above and other features and advantages of example embodiments will become more apparent to those of ordinary skill in the art by describing in detail example embodiments thereof with reference to the attached drawings, in which:

FIG. 1 illustrates an exploded perspective view of a PDP according to an example embodiment;

FIG. 2 illustrates a block diagram of an apparatus for driving the PDP according to an example embodiment;

FIG. 3 illustrates a timing diagram of driving signals output from drivers of the PDP of FIG. 2 according to an example embodiment; and

FIG. 4 illustrates a timing diagram of driving signals output from the drivers of the PDP of FIG. 2 according to another example embodiment; and

FIG. 5 illustrates a timing diagram of driving signals output from drivers of the PDP of FIG. 2 showing address short pulses applied in synchronization with only some of sustain pulses applied to the Y electrodes.

FIG. 6 illustrates a timing diagram of driving signals output from drivers of the PDP of FIG. 2 showing a frame having a plurality of subfields in only some of which address short pulses are applied.

### DETAILED DESCRIPTION OF THE INVENTION

Korean Patent Application No. 10-2007-0079164, filed on Aug. 07, 2007, in the Korean Intellectual Property Office, and entitled: “Apparatus and Method for Driving Plasma Display Panel,” is incorporated by reference herein in its entirety.

Example embodiments will now be described more fully hereinafter with reference to the accompanying drawings; however, example embodiments may be embodied in different forms and should not be construed as limited to the embodiments set fourth herein. Rather, these example embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

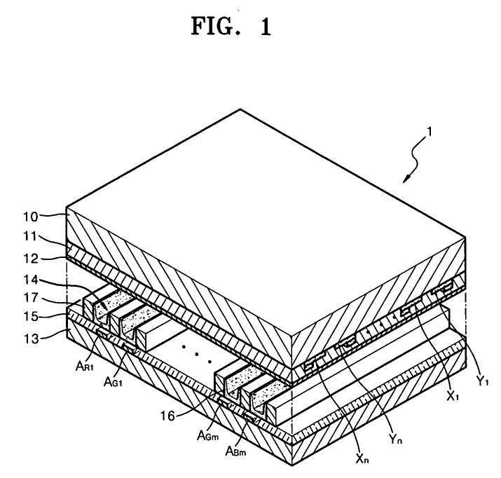

Referring to FIG. 1, a PDP 1 may include a first substrate 10 and a second substrate 13, each having an inner surface and an outer surface. The inner surfaces of the first substrate 10 and the second substrate 13 may face one another. The PDP 1 may include a plurality of electrodes, e.g., A electrodes, Y electrodes, and X electrodes. The A electrodes may include electrodes A_{R1} through A_{Bm}, the Y electrodes may include electrodes Y₁ through Yₙ, and the X electrodes may include electrodes X₁ through Xₙ. The PDP 1 may further include a first dielectric layer 11, a second dielectric layer 15, a phosphor layer 16, barrier ribs 17, and a protective layer 12. The A electrodes A_{R1} through A_{Bm} may be arranged in a pattern on the inner surface of the second substrate 13 and may be arranged in a first direction. The second dielectric layer 15 may overlay and/or bury portions of the A electrodes A_{R1} through A_{Bm}. The barrier ribs 17 may be arranged parallel to the A electrodes A_{R1} through A_{Bm} on a top surface of the second dielectric layer 15. The barrier ribs 17 may partition discharge areas of discharge cells 14 and may prevent optical cross-talk between the discharge cells 14. The phosphor layer 16 may be formed on sidewalls of the barrier ribs 17 and/or on a top surface of the second dielectric layer 15.

The X electrodes X₁ through Xₙ and the Y electrodes Y₁ and Yₙ may be arranged in a pattern on the inner surface of the first substrate 10 and may be arranged in a second direction approximately perpendicular to the first direction, so that portions of the X and Y electrodes may intersect the A electrodes A_{R1} through A_{Bm}. The discharge cells 14 may be formed at crossings between the X electrodes X₁ through Xₙ and Y electrodes Y₁ and Yₙ and the A electrodes A_{R1} through A_{Bm}. Each of the X electrodes X₁ through Xₙ and each of the Y electrodes Y, through Yₙ may be formed by coupling a transparent conductive electrode formed of a material, e.g., indium tin oxide (ITO), with a metal electrode to increase electrical conductivity. In operation, the X electrodes X₁ through Xₙ may act as sustain electrodes, the Y electrodes Y₁ through Yₙ may act as scan electrodes, and the A electrodes A_{R1} through A_{Bm} may act as address electrodes.

The first substrate 10 and the second substrate 13 may be formed of a transparent material, e.g., glass. The protective layer 12 may be formed of one or more materials including a rare earth metal. In particular, the protective layer 12 may include magnesium oxide (MgO) and scandium (Sc). For example, the protective layer 12 may include one or more of: MgO and Sc; MgO, Sc and aluminum (Al); MgO, Sc, Al and calcium (Ca); and MgO, Sc, and zirconium (Zr). When the protective layer 12 is formed from one or more of the above materials, the protective layer 12 may exhibit little or no temperature dependency, may have a relatively high secondary electron emission capacity, and may provide a relatively short discharge delay time.

In operation, if the Y electrodes Y₁ through Yₙ operate as scan electrodes, the Y electrodes Y₁ through Yₙ may receive sequential scan pulses for selected discharge cells. In addition, if the X electrodes X₁ through Xₙ operate as sustain electrodes, the X electrodes X₁ through Xₙ may cause a sustain discharge between the X electrodes X₁ through Xₙ and the Y electrodes Y₁ through Yₙ.

The above configuration is an example of a three electrode surface discharge PDP. Such a three electrode surface discharge PDP, and an apparatus and method for driving the same, are disclosed in U.S. Pat. No. 6,744,218, entitled “Method of Driving a Plasma Display Panel in which the Width of Display Sustain Pulse Varies,” the entire disclosure of which is hereby incorporated by reference in its entirety and for all purposes.

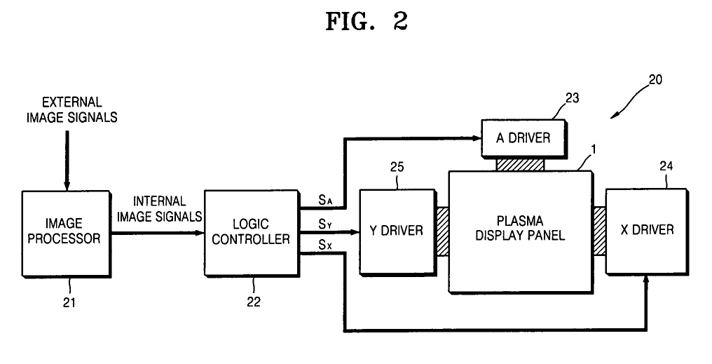

Referring to FIG. 2, an apparatus 20 for driving the PDP 1 may include an image processor 21, a logic controller 22, an A electrode driver 23, an X electrode driver 24, and a Y electrode driver 25. The image processor 21 may convert external analog image signals into digital signals and may generate internal image signals, e.g., red (R), green (G), and blue (B) image signals, a clock signal, and vertical and horizontal sync signals, each with 8 bits. The logic controller 22 may receive the internal image signals from the image processor 21 and may output driving control signals S_{A}, S_{Y}, and S_{X}.

The A electrode driver 23, the X electrode driver 24, and the Y electrode driver 25 may receive the respective driving control signals S_{A}, S_{Y}, and S_{X}. The A electrode driver 23, the X electrode driver 24, and the Y electrode driver 25 may then generate driving signals and may apply the generated driving signals to the corresponding A, X, and Y electrodes. In particular, the A electrode driver 23 may process the driving control signal S_{A}, which may be an address signal, received from logic controller 22 to generate a display data signal, and may apply the generated display data signal to one or more of the A electrodes A_{R1} through A_{Bm}. The X electrode driver 24 may process the driving control signal S_{X} received from the logic controller 22 and may apply a display data signal to one or more of the X electrodes X₁ through Xₙ. The Y electrode driver 25 may process the driving control signal S_{Y} received from the logic controller 22 and may apply a display data signal to one or more of the Y electrodes Y₁ through Yₙ.

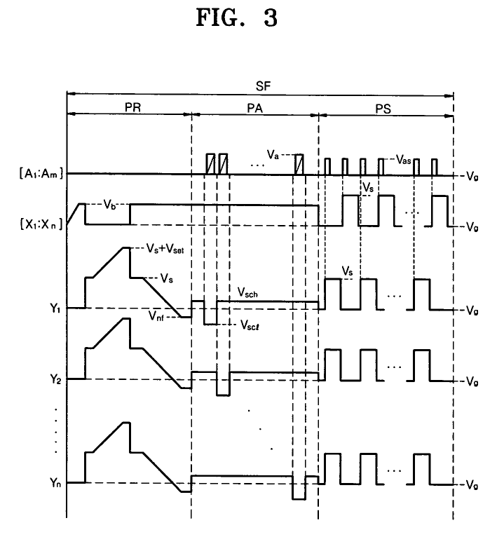

The X electrode driver 24 and/or the Y electrode driver 25 may apply sustain pulses to cause a sustain discharge from at least one of the X electrodes X₁ through Xₙ and the Y electrodes Y₁ through Yₙ. In addition, the A electrode driver 23 may apply address short pulses to the A electrodes A_{R1} through A_{Bm} in synchronization with the sustain pulses. For example, the address short pulses may be aligned with the sustain pulses, such that the address short pulses are applied simultaneously with the sustain pulses as shown in FIG. 3. In another implementation (not shown), the address short pulses may be synchronized with the sustain pulses, and one or more of the address short pulses may be offset from the sustain pulses.

Since the protective layer 12 may be formed with materials including MgO and Sc, large secondary electron emissions may be generated, which may lead to forming a surplus of charged particles in the discharge cells 14. Accordingly, an address discharge may fail to occur in subsequent subfields of a frame, thereby failing to cause a sustain discharge following the address discharge.

In operation, the apparatus 20 may ensure that a sustain discharge occurs between the X electrodes X₁ through Xₙ and the Y electrodes Y₁ through Yₙ by applying address short pulses to the A electrodes A_{R1} through A_{Bm} during the sustain discharge. The address short pulses may have a pulse width less than the pulse width of the sustain pulses. For example, the address short pulses may have a pulse width less than half the pulse width of the address pulses. Further, the address short pulses may have a pulse width less than the pulse width of the sustain pulses.

FIG. 3 illustrates a timing diagram of driving signals output from the drivers of the apparatus 20 of FIG. 2 according to an example embodiment. It is noted, however, that example embodiments are not limited to the driving signals illustrated in FIG. 3, and driving signals different from those shown in FIG. 3 may be output from the drivers of FIG. 2 in other example embodiments.

Referring to FIG. 3, a unit frame for driving the PDP 1 may be divided into a plurality of subfields SF, and the subfields SF may be divided into a reset period PR, an address period PA, and a sustain period PS. During the reset period PR, reset pulses including a rising pulse and a falling pulse may be applied to the Y electrodes Y₁ through Yₙ, and a second voltage, e.g., a bias voltage, may be applied to the X electrodes X₁ through Xₙ. The second voltage may be applied to the X electrodes X₁ through Xₙ when the falling pulse is applied to the Y electrodes Y₁ through Yₙ, so as to perform a reset discharge. The discharge cells 14 may be initialized in response to the reset discharge. The rising pulse in the reset period PR may rise from a sustain discharge voltage Vₛ by raising voltage Vₛₑₜ to a rising maximum voltage Vₛ+Vₛₑₜ. The falling pulse in the reset period PR may fall from the sustain discharge voltage Vₛ to a falling minimum voltage V_{nf}.

During the address period PA, scan pulses may be sequentially applied to the Y electrodes Y₁ through Yₙ, and display data signals may be applied to the A electrodes A_{R1} through A_{Bm} in synchronization with the scan pulses to perform an address discharge. The scan pulses may include a sequential scan high voltage V_{sch} and a scan low voltage V_{scl} lower than the scan high voltage V_{sch}. The display data signals may have a positive address voltage Vₐ in synchronization with the scan pulses with the scan low voltage V_{scl}.

During the sustain period PS, sustain pulses may be alternately applied to the X electrodes X₁ through Xₙ and the Y electrodes Y₁ through Yₙ, to perform a sustain discharge. The sustain discharge may represent brightness according to gray scale weights assigned to the respective subfields SF. The sustain pulses may alternately have a sustain discharge voltage Vₛ and a ground voltage V_{g}. In addition, during the sustain period PS, address short pulses synchronized with the sustain pulses may be applied to the A electrodes A_{R1} through A_{Bm}. The address short pulses may be applied approximately in synchronization with the sustain pulses.

The address short pulses may ensure that at least some negative wall charges accumulated around the X electrodes X₁ through Xₙ and the Y electrodes Y₁ through Yₙ may be moved toward the A electrodes A_{R1} through A_{Bm}. As a result, the discharge volume of the sustain discharge may be increased, which may improve discharge efficiency and brightness. In particular, wall charges resulting from secondary electron emissions may be reduced by applying a greater number of sustain pulses in one frame. Accordingly, the address short pulses may be applied during the sustain period of the rear subfields in the frame.

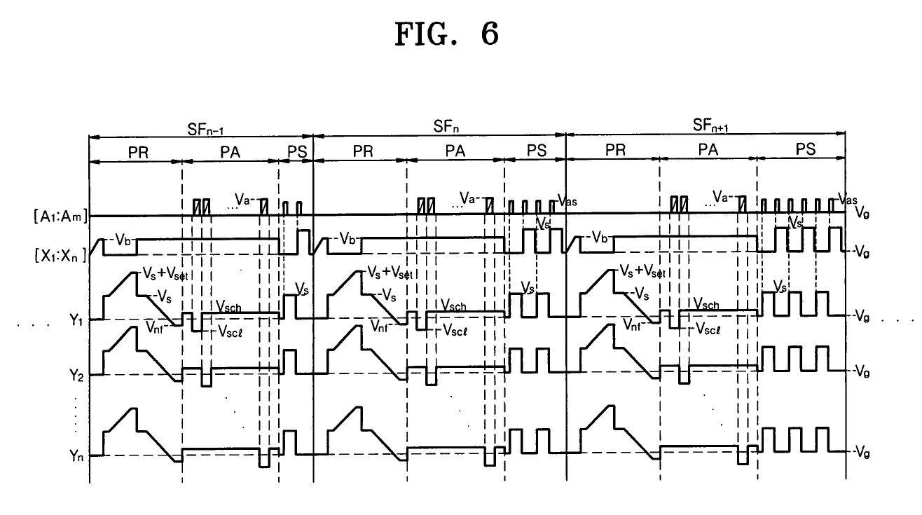

In addition, the address short pulses may be applied during the sustain period of an intermediate subfield of a frame as shown FIG. 6, which may result in stable discharge without a discharge failure in subsequent subfields. For example, when one frame includes zero through eleventh subfields (not shown), the address short pulses may be applied in synchronization with the sustain pulses during the sustain period of the sixth through eighth subfields. Further, the address short pulses may be applied in synchronization with at least one of the sustain pulses applied in the corresponding subfields. That is, the address short pulses may not be applied with all the sustain pulses in the corresponding subfields, but may be applied with only some of the sustain pulses in the corresponding subfields.

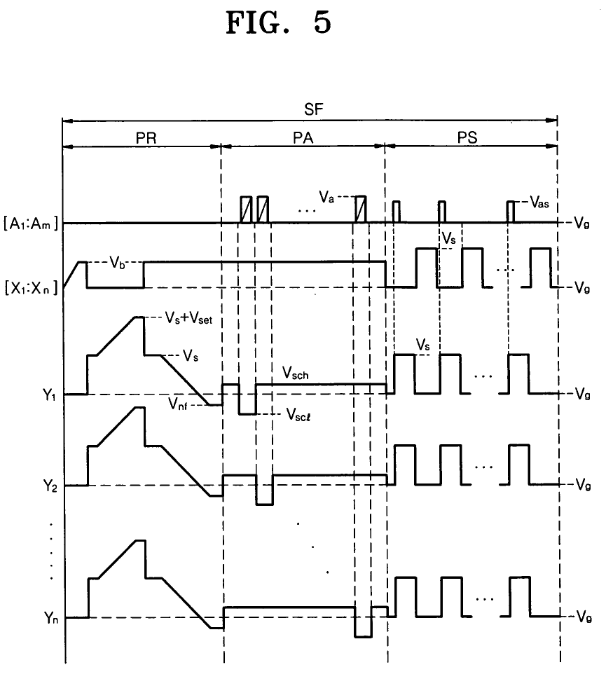

Although in FIG. 3, the address short pulses may be illustrated as being applied in synchronization with all the sustain pulses in the subfields, example embodiments are not limited thereto. For example, the address short pulses may be applied in synchronization with only sustain pulses applied to the X electrodes X₁ through Xₙ, or the address short pulses may be applied in synchronization with only sustain pulses applied to the Y electrodes Y₁ through Yₙ as shown FIG. 5. Furthermore, the address short pulses may have a voltage level Vₐₛ lower than the voltage level Vₛ of the sustain pulses, and the voltage level Vₐₛ may be lower than the voltage level Vₐ of the address pulses. Accordingly, the address short pulses may not cause a main discharge, but may ensure a sustain discharge to occur between the X electrodes X₁ through Xₙ and the Y electrodes Y₁ through Yₙ.

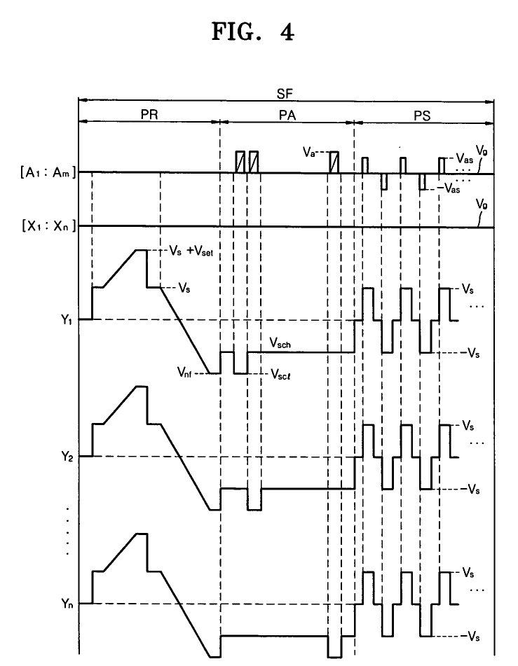

Referring to FIG. 4, a method of driving the PDP 1 varies from the method described with reference to FIG. 3 in that the X electrodes X₁ through Xₙ may be maintained at the ground level voltage V_{g}, and driving signals may be primarily applied to the Y electrodes Y₁ through Yₙ. Because the driving signals may be applied by a driving circuit in the Y electrode driver 25, a driving circuit in the X electrode driver 24 may be simplified.

In this example embodiment, the X electrodes X₁ through Xₙ may be maintained at the ground level voltage V_{g} during the reset period PR, the address period PA, and the sustain period PS. During the sustain period PS, first sustain pulses having a positive voltage level +Vₛ and second sustain pulses having a negative voltage level −Vₛ may be alternately applied to the Y electrodes Y₁ through Yₙ. The address short pulses may include the first address short pulses having the positive voltage level +Vₐₛ applied in synchronization with the first sustain pulses and second address short pulses having the negative voltage level −Vₐₛ applied in synchronization with the second sustain pulses.

When the second address short pulses having the negative voltage level voltage −Vₐₛ are applied to the A electrodes A_{R1} through A_{Bm}, some of positive wall charges accumulated around the Y electrodes Y₁ through Yₙ may be moved to the A electrodes A_{R1} through A_{Bm}. This may result in the discharge volume of the sustain discharge being increased, and thus, improving the discharge efficiency and brightness.

Although the above example embodiments described the address short pulses applied in synchronization with all the sustain pulses, it will be appreciated that the address short pulses may be applied in synchronization to some of the selected sustain pulses. Further, the first address short pulses may have the negative voltage level −Vₐₛ, and the second address short pulses may have the positive voltage level +Vₐₛ.

Example embodiments relate to an apparatus and method for driving a PDP by applying address short pulses during a sustain discharge period to improve brightness and discharge efficiency.

Example embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of example embodiments as set forth in the following claims.

What is claimed is:

1. An apparatus for driving a plasma display panel that includes first and second substrates, X electrodes, Y electrodes, and A electrodes between the substrates, and a protective layer on a surface of at least one of the substrates and formed of a material including magnesium oxide and scandium, the apparatus comprising:
a first driver configured to generate sustain pulses and to apply the sustain pulses to at least one of the X electrodes and the Y electrodes; and
a second driver configured to generate address short pulses and to apply the address short pulses to the A electrodes in synchronization with the sustain pulses.

2. The apparatus as claimed in claim 1, wherein the address short pulses have a pulse width less than a pulse width of the sustain pulses.

3. The apparatus as claimed in claim 2, wherein the width of the address short pulses is less than half the width of the sustain pulses.

4. The apparatus as claimed in claim 1, wherein a voltage level of the address short pulses is lower than a voltage level of the sustain pulses, and
the voltage level of the address short pulses is lower than a voltage level of address pulses applied to the A electrodes during an address period.

5. The apparatus as claimed in claim 1, wherein the address short pulses are aligned with the sustain pulses.

6. The apparatus as claimed in claim 1, wherein the address short pulses are not applied in synchronization with some of the sustain pulses.

7. The apparatus as claimed in claim 1, wherein:
a plurality of subfields are sequentially arranged in one frame, and
the address short pulses are applied to at least one intermediate subfield of the plurality of subfields.

8. The apparatus as claimed in claim 1, wherein:
a plurality of subfields are sequentially arranged in one frame,
the subfields each include an address period and a sustain period,
scan pulses are sequentially applied to the Y electrodes during the address period, and address pulses synchronized with the scan pulses are applied to A electrodes corresponding to discharge cells to be displayed, and
the address short pulses are applied during the sustain period.

9. The apparatus as claimed in claim 1, wherein:
first sustain pulses having a positive voltage level and second sustain pulses having a negative voltage level are alternately applied to the Y electrodes during the sustain period, and
the address short pulses include:
first address short pulses having a positive level applied in synchronization with the first sustain pulses; and
second address short pulses having a negative level applied in synchronization with the second sustain pulses.

10. The apparatus as claimed in claim 1, wherein the protective layer material further includes one or more of aluminum, calcium, or zirconium.

11. A method of driving a plasma display panel that includes first and second substrates, X electrodes, Y electrodes, and A electrodes between the substrates, and a protective layer on a surface of at least one of the substrates and formed of a material including magnesium oxide and scandium, the method comprising:
generating sustain pulses;
applying the sustain pulses to at least one of the X electrodes and the Y electrodes;
generating address short pulses; and
applying the address short pulses to the A electrodes in synchronization with the sustain pulses.

12. The method as claimed in claim 11, wherein the address short pulses have a pulse width less than a pulse width of the sustain pulses.

13. The method as claimed in claim 12, wherein the width of the address short pulses is less than half the width of the sustain pulses.

14. The method as claimed in claim 11, wherein a voltage level of the address short pulses is lower than a voltage level of the sustain pulses, and
the voltage level of the address short pulses is lower than a voltage level of address pulses applied to the A electrodes during an address period.

15. The method as claimed in claim 11, wherein the address short pulses are aligned with the sustain pulses.

16. The method as claimed in claim 11, wherein the address short pulses are not applied in synchronization with some of the sustain pulses.

17. The method as claimed in claim 11, wherein:
a plurality of subfields are arranged sequentially in one frame, and
the address short pulses are applied to at least one intermediate subfield of the plurality of subfields.

18. The method as claimed in claim 11, wherein:
a plurality of subfields are sequentially arranged in one frame,
the subfields each include an address period and a sustain period,
scan pulses are sequentially applied to the Y electrodes during the address period, and address pulses synchronized with the scan pulses are applied to A electrodes corresponding to discharge cells to be displayed, and
the address short pulses are applied during the sustain period.

19. The method as claimed in claim 11, wherein:
first sustain pulses having a positive voltage level and second sustain pulses having a negative voltage level are alternately applied to the Y electrodes during the sustain period, and
the address short pulses include:
first address short pulses having a positive level applied in synchronization with the first sustain pulses; and
second address short pulses having a negative level applied in synchronization with the second sustain pulses.

20. The method as claimed in claim 11, wherein the protective layer material further includes one or more of aluminum, calcium, or zirconium.
